(19) United States
(12) Patent Application Publication
(10) Pub. No.: US 2024/0411537 A1
(43) Pub. Date: Dec. 12, 2024

(54) PROCESSING UPDATES IN MULTI-LAYER EDGE ARCHITECTURE USING CONFLATION OF STATE BUNDLES WITH DEPENDENCIES

(71) Applicant: International Business Machines Corporation, Armonk, NY (US)

(72) Inventors: Nir ROZENBAUM, Yoqneam Illit (IL); Maroon AYOUB, Fassuta (IL)

(21) Appl. No.: 18/329,887

(22) Filed: Jun. 6, 2023

(51) Int. Cl. G06F 8/65; G06F 9/50

(52) U.S. Cl. CPC G06F 8/65; G06F 9/5033

(57) ABSTRACT

An example system includes a processor to receive state bundles including full state bundles and delta bundles with dependencies corresponding to updates received via a transport layer from a lower layer in a multi-layer edge architecture. The processor can conflate the state bundles to generate ready to be processed bundles. The processor can then process the ready to be processed bundles.

### BACKGROUND

The present techniques relate to multi-layer edge architectures. More specifically, the techniques relate to processing updates between layers in multi-layer edge architectures.

Edge computing is becoming more common and collecting and processing huge amounts of data from edge endpoints in multi-layer edge architectures is becoming an increasingly difficult challenge. Multi-layer edge architectures are used to manage a large number of edge endpoints. One main aspect of managing an extremely large number of edge endpoints is the ability to collect status updates from the various edge endpoints and process them efficiently, while maintaining a stable and consistently high performance under high loads, and especially under overload conditions. This aspect introduces considerable challenges regarding how to handle a huge amount of data that is received at the upper layers.

A major problem may occur when data processing is slower than the data reception rate at a certain layer. For, an overload may result if data processing at the central hub layer is slower than the data reception rate. Such an overload may occur when an extremely large number of edge endpoints are updating their status very frequently. An overload may also occur temporarily due to various reasons. For example, if a central hub is disconnected, then regional hubs may continue to collect data from their managed endpoints and send the data via the transport layer. Once the central hub becomes online, the central hub may then receive a data burst that contains millions of updates from all managed endpoints at the same time.

One best practice to handle such cases is to push back on the data being received. For example, a central hub may instruct regional hubs, or other hubs in layers below the central hub, to slow down the rate of updates until the central hub is able to return to a stable state. However, this approach has some negative implications. For example, pushing back may increase the time to get the data and thus the time needed to present the most up to date status to users, etc. The alternative is to process all updates, which may take very long. Moreover, the central hub may spend much time in processing obsolete information, including data that is no longer relevant because newer data is available.

### SUMMARY

According to an embodiment described herein, a system can include a processor to receive state bundles including full state bundles and delta bundles with dependencies corresponding to updates received via a transport layer from a lower layer in a multi-layer edge architecture. The processor can also further conflate the state bundles to generate ready to be processed bundles. The processor can also process the ready to be processed bundles. Thus, the system enables the maintenance of stability and consistent performance under high load and overload. Preferably, the full state bundles include updates of a same type received from the lower layer bundled into a single versioned full state bundle. In this embodiment, the system may more efficiently process updates received from the regional hubs. Preferably, the full state bundles include a managed endpoints bundle that contains a status of all managed endpoints of a reporting regional hub. In this embodiment, the system may more efficiently process updates to endpoints in the regional hubs. Optionally, the full state bundles include an endpoints per resource bundle that contains a mapping between a resource that was deployed and the endpoints associated with the deployed resource. In this embodiment, the mapping is part of a more efficient representation which allows later the optimization in cases where there is most frequent status; this mapping enables an implicit understanding that endpoints that were not reported in the status bundle implicitly have a most frequent status. Optionally, the full state bundles include a resource status bundle that contains a mapping between a resource and a list of endpoints that the resource was deployed to along with their status. In this embodiment, the mapping is part of a more efficient representation which allows later the optimization in cases where there is most frequent status; this mapping enables an implicit understanding that endpoints that were not reported in the status bundle implicitly have a most frequent status. Optionally, the delta state bundles include a resource status delta state bundle. In this embodiment, the status of a resource can be efficiently and timely updated. Optionally, the resource includes an application. In this embodiment, the application can be efficiently tracked across any number of regional hubs and endpoints. Optionally, the processor is to treat endpoints according to a most frequent status and only receive updates for resources on endpoints that have a status other than the most frequent status, where the processor is to treat endpoints that were not reported as having reported the most frequent status. In this embodiment, an even more efficient manner of updating endpoints can be used when a most frequent status is available. Preferably, the system further includes a number of conflation units, where each of the number of conflation units conflate bundles of a group of dependent bundles and sends ready to be processed bundles to a dispatcher for processing in a predefined order based on the dependencies. In this embodiment, the bundles may be efficiently and accurately processed. Preferably, the system further includes a transport reader that reads messages including the state bundles from the transport layer, extracts the state bundles, and inserts the extracted state bundles into a matching conflation unit. In this embodiment, bundles can be efficiently prepared for conflation. Preferably, the system further includes a dispatcher to request a ready to be processed bundle and assign a worker from a workers pool to process the ready to be processed bundle. In this embodiment, bundles may be efficiently processed in parallel using multiple workers.

According to another embodiment described herein, a method can include receiving, via a processor, state bundles including full state bundles and delta bundles with dependencies corresponding to updates received via a transport layer from a lower layer in a multi-layer edge architecture. The method can further include conflating, via the processor, the state bundles to generate ready to be processed bundles. The method can also further include processing, via the processor, the ready to be processed bundles. Thus, the method enables the maintenance of stability and consistent performance under high load and overload. Preferably, processing the ready to be processed bundles includes processing different state bundle types in a predefined order that is based the dependencies between the different state bundle types. In this embodiment, the method provides efficient conflation of data while processing rate is slower than the rate of data received by transport. Preferably, processing the ready to be processed bundles is executed using a number of assigned workers, where the number of workers handle ready to be processed bundles. In this embodiment, the method can optimize parallel processing by multiple workers that are handling ready to be processed bundles of the regional hubs, while preserving correctness. Preferably, processing the ready to be processed bundles is executed using a workers pool. In this embodiment, the method enables control over allocated resources, and thus avoids memory explosions. Optionally, receiving state bundles includes receiving full state bundles from a regional hub in response to a disconnection with the regional hub, and transmitting an acknowledgement to the regional hub and receiving a delta state bundle in response to transmitting the acknowledgement. In this embodiment, resilience to disconnections with endpoints is increased. Optionally, the method includes reporting a latest status of the processing of the ready to be processed bundles. In this embodiment, the delay of processing with the latest status reported is minimized. Preferably, conflating the bundles is executed in response to detecting that a processing rate of the processor is slower than the rate of data received by the transport layer. In this embodiment, the method provides efficient conflation of data while processing rate is slower than the rate of data received by transport. Optionally, processing the ready to be processed bundles includes processing groups of dependent bundles received from a same regional hub one at a time. In this embodiment, the method can minimize contention between multiple workers to enhance performance by natural sharing. Preferably, the method includes receiving the state bundles from a number of regional hubs and conflating the state bundles based on their dependencies. In this embodiment, updates to any number of regional hubs may be efficiently and fairly processed.

According to another embodiment described herein, a computer program product for processing updates in multi-layer edge architectures can include computer-readable storage medium having program code embodied therewith. The program code executable by a processor to cause the processor to receive state bundles including full state bundles and delta bundles with dependencies corresponding to updates received via a transport layer from a lower layer in a multi-layer edge architecture. The program code can also cause the processor to conflate the state bundles to generate ready to be processed bundles. The program code can also cause the processor to process the ready to be processed bundles. Thus, the computer program product enables the maintenance of stability and consistent performance under high load and overload. Preferably, the program code can also cause the processor to process different state bundle types in a predefined order that is based the dependencies between the different state bundle types. In this embodiment, the computer program product provides efficient, conflation of data while processing rate is slower than the rate of data received by transport. Preferably, the program code can also cause the processor to process the ready to be processed bundles using a number of assigned workers. In this embodiment, parallel processing by multiple workers is optimized each handling at any given point in time in our example a different regional hub (or even groups of dependent bundles from the same regional hub) while preserving correctness. Preferably, the program code can also cause the processor to also further process the ready to be processed bundles using a workers pool. In this embodiment, the computer program product enables control over allocated resources and thus avoids memory explosions. Optionally, the program code can also cause the processor to receive full state bundles from a regional hub in response to a disconnection with the regional hub, and transmit an acknowledgement to the regional hub and receive a delta state bundle in response to transmitting the acknowledgement. In this embodiment, resiliency to disconnections is increased.

### BRIEF DESCRIPTION OF THE SEVERAL VIEWS OF THE DRAWINGS

FIG. 1 is a block diagram of an example computing environment that contains an example of an environment for the execution of at least some of the computer code involved in performing the inventive methods, such as a hybrid state bundle processor module;

FIG. 2 is an example tangible, non-transitory computer-readable medium that can process hybrid state bundles using a conflation mechanism;

FIG. 3 is a process flow diagram of an example method that can process hybrid state bundles using conflation;

FIG. 4 is a high-level block diagram of an example system for processing hybrid state bundles at a centralized hub using conflation;

FIG. 5 is a block diagram depicting an example dependency chain between an example set of different types of state bundles;

FIG. 6 is a block diagram of an example system for processing hybrid state bundles using a conflation mechanism at a receiving layer; and

FIG. 7 is a block diagram of an example system for dispatching ready to be processed bundles to workers in a worker pool.

### DETAILED DESCRIPTION

According to embodiments of the present disclosure, updates from the same type from various edge endpoints are bundled and sent as one message from one layer to another layer above in a multi-layer architecture. An efficient representation of the collected data is enabled by using bundles with dependencies between them, while ranking the bundles by priority based on the dependencies. In addition, the embodiments use a hybrid mode of full state bundles (as in state replication) and delta state bundles that include incremental changes (as in an event bus). As used herein, a full state bundle represents a full state of a resource at a given point in time. As used herein, a delta state bundle represents incremental changes to a resource since a last received full state bundle. In an event bus, an event is used to report incremental changes, but the event bus cannot tolerate any event loss or re-order. In state replication, each message maintains the latest status or full state, and therefore state replication can tolerate any losses. State replication also works well in disconnected scenarios and can be easily adjusted for load. For example, state replication may be used to pull a latest full state when possible. For example, if the resource is an application that is deployed to 3,000 managed endpoints under the same regional hub, then a full state bundle from that regional hub to the central hub includes the state of that application for all 3,000 managed endpoints. On the other hand, a delta state bundle in the above example may include partial (or full) state of the application for a subset of the managed endpoints. For example, a delta state bundle may include a partial or full state of the application for a subset of 1,200 managed endpoints. The embodiments described herein use a hybrid mode of the two and thus provide the benefits of both worlds. Furthermore, the embodiments provide an efficient conflation mechanism at a receiving layer in order to make sure that, every time a bundle is processed, the bundle is the most important bundle to be processed and does not contain obsolete information. Thus, embodiments of the present disclosure enable maintaining a stable and consistent high performance under high load and overload in multi-layer edge architectures, where full history of changes is not required, but rather the latest state is required. In general, in edge use cases where connectivity may be lost from time to time, it is not a good practice to use event-driven architectures, because event driven architectures usually cannot tolerate any event loss or re-order. The embodiments herein bundle changes together and thus aggregate them in one of the layers of a multi-layer architecture and send them periodically to a layer above. Thus, the embodiments herein are also not event-driven and therefore can tolerate event loss or re-order. Moreover, the combination of using bundles of data with dependencies between them, using a hybrid mode of full state and delta state bundles and a sophisticated conflation mechanism, makes the processing stage efficient as well as limits that number of resources that are held in memory.

In addition, the embodiments herein may be used in a variety of use cases. Some examples of such use cases include telecommunication networks, such as in virtualized radio access networks (vRANs). For example, a vRAN may involve the management of more than 1,000,000 managed endpoints in a multi-layer architecture. Other use cases include retail use cases, such as in stores or restaurants. Additional use cases include industrial use cases, such as in robotics and automation. Further use cases include fleet management use cases, such as in trucks or connected cars. For example, each vehicle may report the location of the vehicle, the speed of the vehicle, the direction of the vehicle, among other information. For example, such vehicle information may be used for prevent vehicle collisions. In a multi-layer architecture, such vehicle information may be reported on a city level, then aggregated to a state level, then aggregated to a national level or global level. Other potential uses cases include smart city use cases, such as in street cameras, and more. The embodiments herein can thus be implemented in any multi-layer architecture with any number of layers or numbers of managed endpoints.

As one specific example of a use case, high-scale tests were run in a three layer simulated environment in order to test the efficiency of the embodiments and results were impressive. In particular, 100 Regional Hubs (RHs) were simulated in one test and 1,000 RHs were simulated in another test, each of them managing 1,000 managed clusters representing edge endpoints. In the first test, 10 applications were applied to all edge clusters and in the second test, 100 applications were applied to all edge clusters. The time elapsed was measured from the moment that collection of the data from the edge endpoints was started up until the system completed processing the collected data by inserting the data into a scalable database. The time taken for 10 applications, of 100 RHs, each with 1,000 managed clusters, for a total of 100,000 managed clusters and 1,000,000 applications was 45 minutes without using the embodiments. By contrast, using the embodiments herein, the time elapsed from data collection to processing was only 45 seconds. Similarly, in the second test with 100 applications run on 1,000 RHs, each with 1,000 managed clusters, for a total of 1,000,000 managed clusters and 100,000,000 applications, not using the embodiments herein resulted in an elapsed time of greater than three days. By contrast, using the embodiments here, the elapsed time was only 25 minutes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as [Fill in this space with the name of the inventive code block. This description should reveal to the reader what the inventive code does at a general level. Illustrative examples: “improved cloud orchestration code,” “new ML algorithm code,” etc.] 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

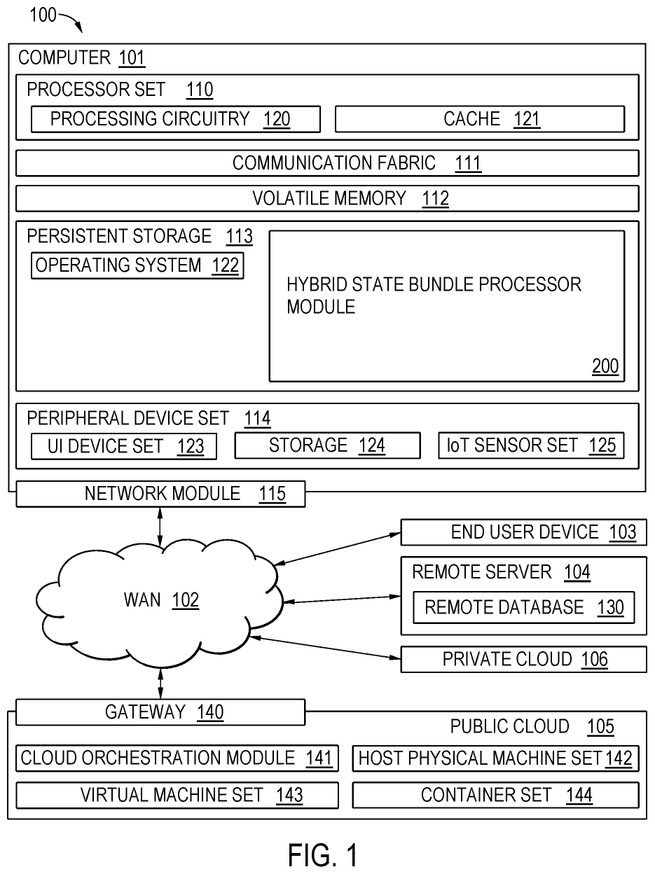

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

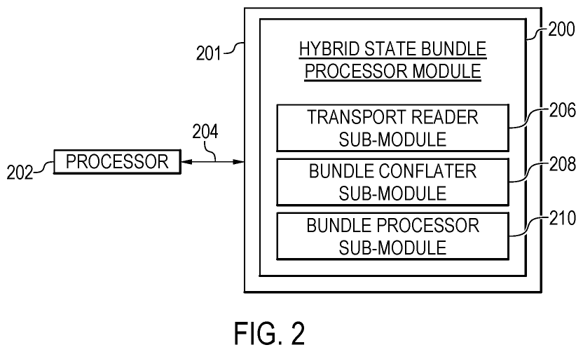

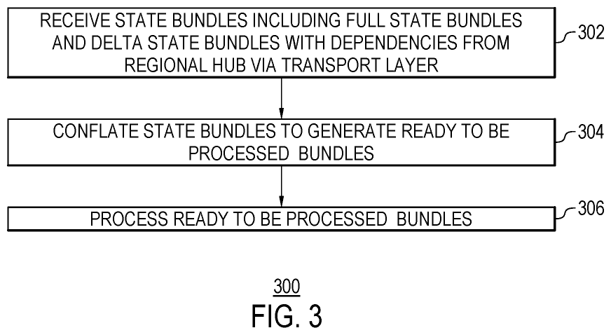

Referring now to FIG. 2, a block diagram is depicted of an example tangible, non-transitory computer-readable medium 201 that can process hybrid state bundles using a conflation mechanism. The tangible, non-transitory, computer-readable medium 201 may be accessed by a processor 202 over a computer interconnect 204. Furthermore, the tangible, non-transitory, computer-readable medium 201 may include code to direct the processor 202 to perform the operations of the method 300 of FIG. 3.

The various software components discussed herein may be stored on the tangible, non-transitory, computer-readable medium 201, as indicated in FIG. 2. For example, the hybrid state bundle processor module 200 can include a transport reader sub-module 206 that includes code to receive state bundles including full state bundles and delta bundles with dependencies corresponding to updates received via a transport layer from a lower layer in a multi-layer edge architecture. The transport reader sub-module 206 also includes code to read messages including the state bundles from the transport layer, extracts the state bundles, and inserts the extracted state bundles into a matching conflation unit. In some examples, the transport reader sub-module 206 includes code to receive full state bundles from a regional hub in response to a disconnection with the regional hub, and transmit an acknowledgement to the regional hub and receive a delta state bundle in response to transmitting the acknowledgement. The hybrid state bundle processor module 200 can also include a bundle conflater sub-module 208 that includes code to conflate the state bundles to generate ready to be processed bundles. The bundle conflater sub-module 208 further includes code to conflate the bundles in response to detecting that a processing rate of the processor is slower than the rate of data received by the transport layer. In some examples, the bundle conflater sub-module 208 includes code to conflate bundles of a group of dependent bundles and sends ready to be processed bundles to a dispatcher for processing in a predefined order based on the dependencies. The hybrid state bundle processor module 200 can also include a bundle processor sub-module 210 that includes code to process the ready to be processed bundles. The bundle processor sub-module 210 also includes code to process different state bundle types in a predefined order that is based the dependencies between the different state bundle types. In various examples, the bundle processor sub-module 210 also includes code to process the ready to be processed bundles using a number of assigned workers. In some examples, the bundle processor sub-module 210 also includes code to process the ready to be processed bundles using a workers pool. In some examples, the bundle processor sub-module 210 also includes code to report a latest status of the processing of the ready to be processed bundles.

It is to be understood that any number of additional software components not shown in FIG. 2 may be included within the tangible, non-transitory, computer-readable medium 201, depending on the specific application or use case. For example, a dispatcher sub-module (not shown) may include code to request a ready to be processed bundle and assign a worker from a workers pool to process the ready to be processed bundle.

FIG. 3 is a process flow diagram of an example method that can process hybrid state bundles using conflation. The method 300 can be implemented with any suitable computing device, such as the computer 101 of FIG. 1. For example, the methods described below can be implemented by the processor set 110 of FIG. 1.

At block 302, state bundles including full state bundles and delta state bundles with dependencies are received from a regional hub via a transport layer. In various examples, the state bundles may be received from a number of different regional hubs. In some examples, full state bundles may be received from a regional hub in response to a disconnection with the regional hub. An acknowledgement may then be transmitted to the regional hub and a delta state bundle received in response to transmitting the acknowledgement.

At block 304, the state bundles are conflated to generate ready to be processed bundles. In some examples, the types of bundles may include: a managed clusters full state bundle, clusters per resource full state bundle, a resource status full state bundle, and a resource status delta state bundle. For example, the resource may be an application, a policy, or a model, such as a trained artificial intelligence model.

At block 306, the ready to be processed bundles are processed. For example, different state bundle types may be processed based on the dependencies between the different state bundle types. In some examples, the ready to be processed bundles may be processed using a number of assigned workers. In various examples, the number of workers may handle ready to be processed bundles. In some examples, the processing may be executed using a workers pool. In various examples, a processing rate of the processor is slower than the rate of data received by the transport layer. In some examples, bundles received from a regional hub may be processed one at a time. In some examples, groups of dependent bundles received from a same regional hub may be processed one at a time.

The process flow diagram of FIG. 3 is not intended to indicate that the operations of the method 300 are to be executed in any particular order, or that all of the operations of the method 300 are to be included in every case. Additionally, the method 300 can include any suitable number of additional operations. For example, the method 300 may further include reporting a latest status of the processing of the ready to be processed bundles.

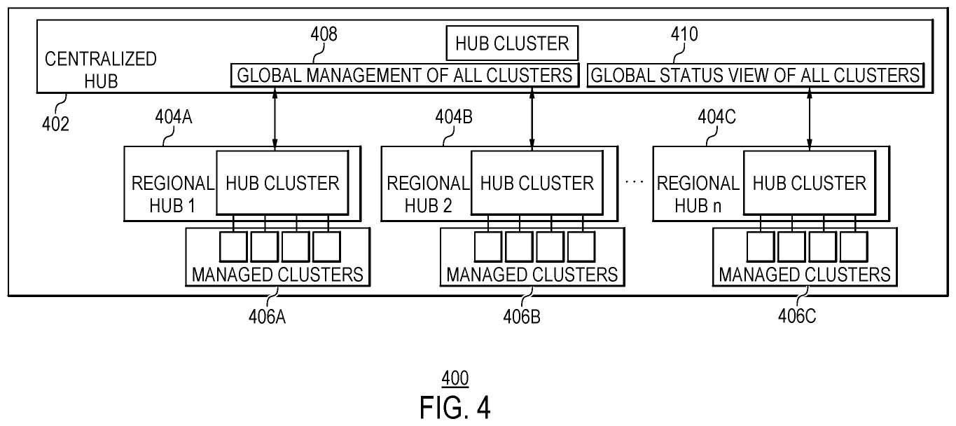

With reference now to FIG. 4, a block diagram shows an example system for processing hybrid state bundles at a centralized hub using conflation. The example system 400 of FIG. 4 includes a centralized hub 402 communicatively coupled to a set of regional hubs 404A. 404B, and 404C. The regional hubs 404A, 404B, 404C are each communicatively coupled to a corresponding set of managed clusters 406A, 406B, and 406C, respectively. The centralized hub 402 includes a global management of all clusters 408 and a global status view of all clusters 410. For example, the global management of all clusters 408 may include tools to deploy various applications or other resources to various end points of the managed clusters 406A, 406B, and 406C. As one examples, the application may be a collision avoidance algorithm that is deployed to a subset of vehicles in a smart car network. In various examples, the global status view of all cluster 410 may include a view of all the updated statuses of the regional hubs and managed clusters, which are the end points in the example of FIG. 4. All this information may have been efficiently and accurately obtained using the embodiments described herein.

In the example of FIG. 4, a three layer architecture is used as one example of a centralized hub that receives updates from various regional hubs. In various examples, updates from the same type are bundled to a single versioned full state bundle message that contains the latest status of each resource. The full state bundle message may include the latest status of all resources. For example, all managed clusters 406A, 406B, and 406C may report the status of some resource to their corresponding regional hubs 404A, 404B, and 404C. As one example, an application that was deployed to a cluster may be in status of pending, running, or may have an error. The regional hubs 404A, 404B, and 404C may then bundle all updates from the same type to a single versioned message and send the message via the transport layer to the layer above. In various examples, each of the messages in the updates contains a version field. For example, the updates may be resource status updates, such as application status updates. In the example of system 400, the layer above the regional hub layer is the centralized hub 402.

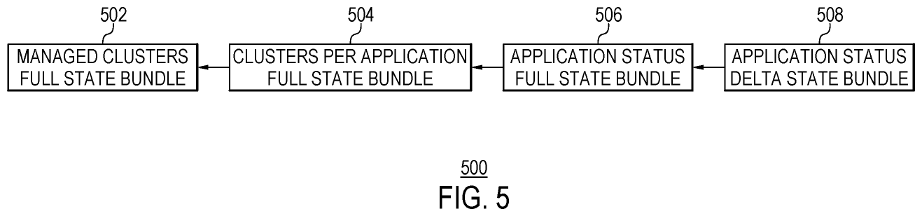

In various examples, the data that is reported as full state bundles is represented with dependencies between bundles to allow efficient processing later. In some examples, each of the regional hubs 404A, 404B, 404C may be managing a set of clusters (or edge endpoints) 406A. 406B, and 406C, and the centralized hub 402 may apply a resource to the managed clusters 406A, 406B, and 406C through the regional hubs 404A, 404B, and 404C. For example, the resource may include any number of applications, policies, artificial intelligence (AI) models, etc. The status of those resources are to then be later reported back to the centralized hub 402. To continue with applications as a specific example, then the data may be represented using the following full state bundles: a managed clusters (MC) bundle, a clusters per application (CpA) bundle, and an application status bundle. These bundles are discussed in greater detail in the context of the example dependency chain of FIG. 5. As described in FIG. 5, a set of rules may be established for a hybrid mode operation using a combination of full state bundles and delta state bundles.

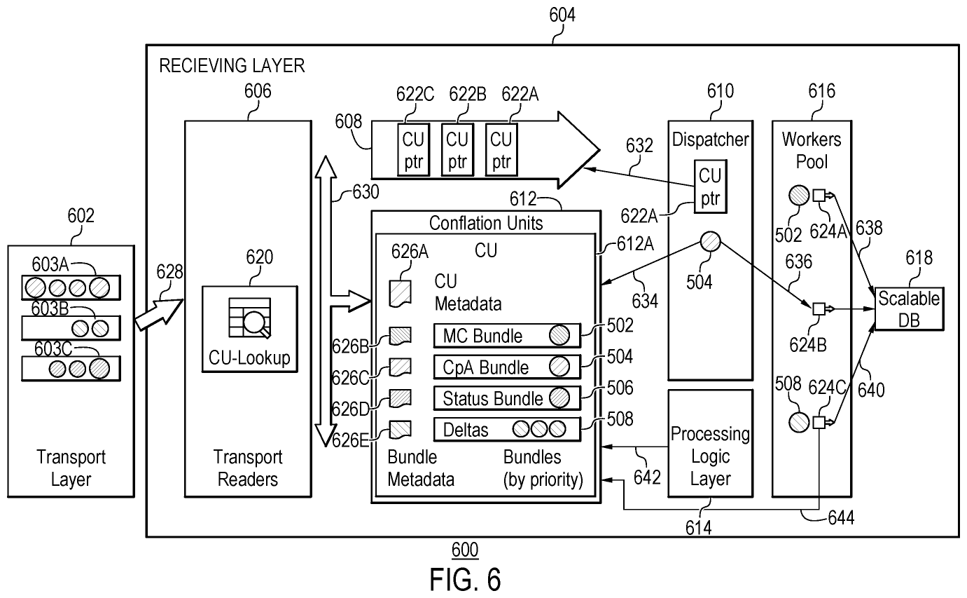

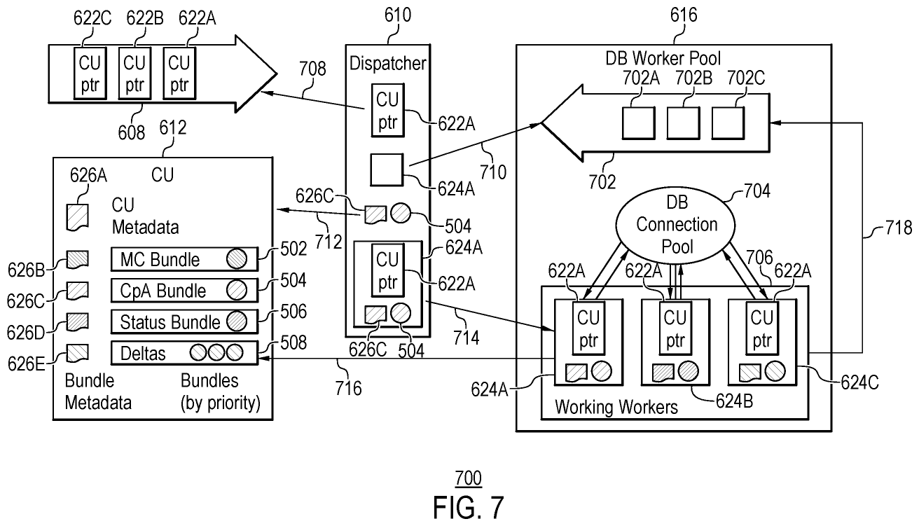

Still referring to FIG. 4, the centralized hub 402 may perform a conflation on the incoming bundles in the receiving layer. An example of such a receiving layer is described with respect to FIG. 6. For the simplicity of explanation, FIGS. 6 and 7 show an example where the processing logic for handling the incoming data is to insert the bundles into a scalable database. However, in various examples, this could be any other processing logic. One skilled in the art can easily generalize the processing logic to any suitable form of handling logic.

It is to be understood that the block diagram of FIG. 4 is not intended to indicate that the system 400 is to include all of the components shown in FIG. 4. Rather, the system 400 can include fewer or additional components not illustrated in FIG. 4 (e.g., additional layers, or additional clusters, or types of managed endpoints, additional types of resources, etc.). For example, the system 400 may be used at multiple layers between every two consecutive layers in a multi-layer architecture having many layers. For example, the managed clusters may be any other suitable type of managed endpoint.

With reference now to FIG. 5, a block diagram shows an example dependency chain between an example set of different types of state bundles. The example dependency chain 500 of FIG. 5 includes a managed clusters full state bundle 502. The managed clusters full state bundle 502 is shown depending from a clusters per application full state bundle 504. The clusters per application full state bundle 504 is shown depending from an application status full state bundle 506. The application status full state bundle 506 is in turn shown depending from an application status delta state bundle 508.

In the example of FIG. 5, the Managed Clusters (MCs) bundle is a bundle that is sent from the regional hub to the central hub and contains status of all managed clusters of the reporting regional hub. For example, the MC bundles may include a cluster id, cluster is online/offline, metadata, etc.

In various examples, the Clusters per Application (CpA) full state bundle 504 is a bundle that contains a mapping between an application that was deployed and the clusters that the application applies to. For example, the mapping may take the form: {app1: [cluster1, cluster2], app2: [cluster2, cluster4], app3: [ . . . }. Alternatively, the CpA full state bundle 504 may be a mapping between any other resource and associated clusters. For example, other resources may include policies, models, etc. In the example of FIG. 5, the CpA full state bundle 504 has dependency on the Managed Clusters full state bundle 502 because the centralized hub cannot deploy an application or any other resource to a cluster without knowing that the cluster exists.

In various examples, the Application Status full state bundle 506 is a bundle that contains a mapping between an application and a list of clusters it was deployed to along with their status. In some examples, where assumptions can be made about the most frequent status, this representation can then further be optimized to a very compact representation. For example, if the assumption can be made that most of the applications are in status “Running” most of the time, on most of the clusters, then regional hubs can report only applications that run on clusters and are in a status other than “Running.” The centralized hub may then accordingly be configured to treat clusters that are reported in “Clusters Per Application” bundle and are not reported in current bundle as “Running”. The Application Status full state bundle 506 bundle has dependency on the CpA full state bundle 504 because reference to the status of an application on a cluster depends on the knowledge that an application was deployed to a cluster. In addition, in some examples, if a compact representation is used, then there may be a strong dependency on CpA full state bundle.

Still referring to FIG. 5, in some examples, delta state bundles may also be used. The delta state bundles may contain incremental changes. For example, to continuing the same example with the chain of dependencies, a delta state bundle may be present at the end of the chain that includes incremental changes of any resource status, such as an application status in the example of FIG. 5. In some examples, each regional hub may be configured to check if something has changed every ‘X’ seconds or any other suitable configurable time. In various examples, the regional hub may be configured to send the bundles in response to detecting that there were changes. In some examples, during the time period between checks, the regional hub may also be configured to aggregate changes and put them inside a single bundle, while making sure to increase the bundle version on every change to verify that versions are monotonically increasing. Such versioning may be used by the conflation mechanism later on.

In the example of FIG. 5, the delta state bundle has dependency on the application status full state bundle, since it reports incremental changes that happened since the last time a full state bundle was sent. Notably, changes that happened earlier are not relevant, since the full state bundle already covers such earlier changes. In the example of FIG. 5, the application status delta state bundle 508 may thus include a subset of the applications with a subset of clusters. In particular, the application status delta state bundle 508 may only include the ones that have changed their status since the full state bundle. As one specific example, the application status delta state bundle 508 may include the information: {app1: [{cluster1: completed}], app2: [{cluster4: pending}]}.

With the addition of delta bundles, an example dependency chain 500 may therefore include all elements shown in FIG. 5. A hybrid mode may thus include two modes representing a mode of state replication and an event bus, the latter mode using delta state bundles and the other using full state bundles. In various examples, in order to optimize the use of this hybrid mode, a set of rules may be defined for when the regional hub sends full or delta state bundles. For example, delta state bundles may generally be used. Full state bundles may then be sent at configurable intervals of time. For example, once every “X” seconds, each regional hub may send a full state bundle to increase resiliency to disconnections or package loss. In some examples, the full state bundles may be sent after a configurable number of delta bundles. For example, once every “Y” number of delta bundles, each regional hub may send a full state bundle.

In some examples, in response to receiving any sign for being disconnected from the central hub, a regional hub may switch to sending full state bundles only. Then, upon successful reconnection with the central hub, the regional hub can return back to sending delta state bundles. For example, a regional hub may switch back to sending delta state bundles in response to receiving an acknowledgement (Ack) from a central hub that a bundle was received successfully. One reason for temporarily switching to full state bundles is that, upon disconnection, the sending regional hub may not know for sure which of the bundles arrived and which did not arrive. Therefore, sending full state bundles during this time may help maintain consistency.

It is to be understood that the block diagram of FIG. 5 is not intended to indicate that the dependency chain 500 are to include all of the components shown in FIG. 5. Rather, the dependency chain 500 can include fewer or additional components not illustrated in FIG. 5 (e.g., additional types of state bundles, or additional dependencies, resources, or types of managed endpoints, etc.). For example, the dependency chain 500 may not include any delta state bundles. In various examples, one skilled in the art will appreciate that the dependency chain 500 may be generalized to various other resources by as many other examples fit this pattern. Examples of such alternative resources may include edge endpoints that are drones or robots that report status of their current mission, such as Running, Pending, Completed, etc. Another example includes edge endpoints that report status of governance policies applied to them, such as a policy that the disk has to be encrypted. Yet another example includes edge clusters that report status of an artificial intelligence (AI) model that was deployed to them. In other examples, the edge endpoints may be robots that report status of their battery, among other various types of resources that may fit such a dependency chain. As one example of a multiple dependencies, three dependency chains may share the same root managed cluster bundle: Managed clusters<-CpA<-application full state bundle<-application delta state, Managed clusters<-clusters per AI model, and Managed clusters<-clusters per governance policy<-policy status full state bundle<-policy status delta state bundle.

With reference now to FIG. 6, a block diagram shows an example system for processing hybrid state bundles using a conflation mechanism at a receiving layer. The example system 600 of FIG. 6 includes a transport layer 602 communicatively coupled to a receiving layer 604. The transport layer 602 includes objects 603A, 603B, and 603C received from various regional hubs. The receiving layer 604 includes transport readers 606. The receiving layer 604 also includes a conflation unit (CU) ready-queue 608. The receiving layer 604 further includes a dispatcher 610 communicatively coupled to the CU ready-queue 608. The receiving layer 604 also further includes conflation units 612 communicatively coupled to the transport readers 606 and the dispatcher 610. The receiving layer 604 also further includes a processing logic layer 614. The receiving layer 604 includes a workers pool 616 communicatively coupled to the dispatcher 610. The receiving layer further includes a scalable database (DB) 618 communicatively coupled to the workers pool 616. The receiving layer 604 also includes a CU-lookup data structure 620 communicatively coupled to the transport readers 606. The CU ready-queue 608 includes conflation unit (CU) pointers 622A, 622B, and 622C. The dispatcher 610 includes the CU pointer 622A. The workers pool 616 includes working workers 624A, 624B, and 624C. The example CU 612A shown in FIG. 6 includes an MC bundle 502, a CpA bundle 504, a status bundle 506, and a delta bundle 508. As shown in FIG. 6, the bundles 502-508 are arranged in order of priority, which may be based on dependencies as described in FIG. 5. The CU 612A further includes metadata, including CU metadata 626A, MC bundle metadata 626B, CpA bundle metadata 626C, status bundle metadata 626D, and delta bundle metadata 626E. For example, the CU metadata 626A includes metadata such as an offset to commit to the transport layer once the bundle is processed, whether the bundle already processed or not, and an identifier of fragment ID in case the message was too big and therefore was fragmented when the message was sent. In various examples, the bundle metadata 626B, 626C, 626D, and 626E includes metadata. For example, the bundle metadata 626B, 626C, 626D, and 626E may include similar types of metadata as the CU metadata 626A.

In the example system 600 of FIG. 6, the transport reader 606 reads messages from the transport layer 602, as indicated by an arrow 628. The transport reader 606 extracts bundles and inserts the extracted bundles into matching conflation units 612, as indicated by arrows 630. For example, each of the transport readers 606 may constantly read messages from the transport layer 602. When an message is read, the transport reader 606 can parse the object to obtain the basic information used by a corresponding CU 612. In various examples, this basic information may include the unique identifier of the originating regional hub and a bundle type. For example, as shown in FIG. 6, the bundle types for CU 612A include an MC bundle 502, a CpA bundle 504, a status bundle 506, and a delta bundle 508. The transport reader 606 can then insert the bundle into a matching CU 612. In various examples, to find the matching CU 612 for a bundle, the transport readers 606 use a CU-Lookup data structure 620. For example, the CU-Lookup data structure 620 may be a hash table.

In various examples, the CU Ready-Queue 608 may be a simple first-in first-out (FIFO) queue, where each element in the queue holds the ID or pointer of a CU 612. In particular, once the conditions are met and a the CU contain at least one ready to be processed bundle, the CU pointer is inserted to the CU Ready-Queue 608. It could be that newer bundles may replace the current bundle, but the pointer will keep making progress in the CU Ready-Queue 608 without any relation to newer bundles. This keep fairness between the different regional hubs, since their pointer is not moved to end of queue once they have new updates, which could result in starvation of a specific regional hub. The CU Ready-Queue 608 is thus used to hold the IDs of CUs 612 that have at least one bundle that is ready to be processed. For example, as in the example of FIG. 6, the at least one bundle may be ready to be inserted to a scalable database 618. In various examples, a CU 612 pushes its ID into the end of the CU Ready-Queue 608 when two conditions are met: the CU 612 has at least one bundle that is ready to be processed, and the CU ID is not already in the CU Ready-Queue 608 and is not being served by a worker. The second condition means that after the CU ID was inserted to the CU Ready-Queue 608 the following insert can occur only after the dispatcher obtained a bundle from the CU 612 and then the worker reported that the bundle processing has been completed, whether successfully or not. In various examples, the dispatcher 610 is thus blocked if the CU Ready-Queue 608 is empty.

As described in FIG. 6, the CU 612 is a logical component that is used to conflate bundles inserted by the transport reader and provide ready to be processed bundles to the dispatcher 610. In the example of FIG. 6, there are four main bundles that each regional hub reports with dependency relations among them: a Managed Clusters bundle (MC) 502, a Cluster-per-Application bundle (CpA) 504 having a dependency on MC bundle, an application status bundle 506 having a dependency on Cluster-per-Application bundle, and an application status delta bundle 508 having a dependency on application status full state bundle. As used herein, dependency means that the dependent base bundle version is indicated in the bundle metadata. Due to these dependencies, the CU 612 may always attempt to deliver bundles to the dispatcher 610 according to the order they are listed above. For example, MC bundles are always attempted to be delivered to the dispatcher 610 first and Delta bundles are always attempted to be delivered to the dispatcher 610 last. A CU 612 does not consider a bundle ready if the bundle with a specific version that the particular CU 612 depends on has not been successfully processed. Each CU 612 may thus store in memory at most one bundle of each type (the latest unprocessed bundle), if present. For each bundle type, the CU 612 also maintains metadata to assist with management tasks, such as indicating if the bundle has been processed successfully or not, or indicating an offset commit, among other management tasks.

In various examples, the CU 612 can be used to implement various functions. For example, the CU 612 can implement an InsertBundle function. The InsertBundle function can be invoked by a transport reader, which provides in addition to the bundle itself, also basic bundle transport metadata. When a new bundle is inserted, the conflation mechanism of system 600 may be handling old bundles that are no longer relevant. In various examples, in response to detecting that the received bundle is a full state bundle, the conflation mechanism replaces the existing bundle from the same type, if present, and keeps only the new full state bundle. In some examples, in response to detecting that the received bundle is a delta state bundle, the conflation mechanism merges the received bundle with the existing bundle from the same type, if present, while making sure that newer bundle overrides values of keys that exist in both bundles. In both examples, whether the received bundle is detected as a full state or a delta state bundle, the metadata 626B, 626C, 626D, or 626E of the bundle is updated accordingly. In addition, assuming the received bundle version was “X”, then the conflation mechanism removes from its priority queue all the bundles that depend on version smaller than version “X”. If certain conditions are met, then the CU inserts its ID to the CU Ready-Queue 608. For example, in response to detecting that the bundle is ready to be processed and the CU is not already in the queue, the CU inserts its ID to the CU Ready-Queue 608.

In addition, the CU 612 can also implement a GetBundle function. For example, the dispatcher may invoke the GetBundle function to obtain the next bundle to process. The CU 612 provides a copy of the next bundle to be processed along with its metadata. The reason for providing a copy of the bundle or a copy of the reference is to allow the CU 612 to be updated while the worker 624A is processing the bundle 504. The CU 612 then provides the next ready bundle according to bundle type priority. In the example of FIG. 6, the MC bundle 502 is processed first, then Cluster-per-Application bundle 504, Application-status bundle 506, and finally delta bundles 508. In various examples, delta bundles 508 include deltas that are grouped together as a group or new bundle type, including of all the new deltas that should be processed.

Furthermore, the CU 612 can also implement a ReportBundleProcessed function. For example, the ReportBundleProcessed function can be invoked by the workers 624A, 624B, and 624C to report that a bundle has been processed. The worker 624A, 624B, or 624C provides the bundles metadata obtained using the GetBundle function, and an indication of whether the bundle processing has been completed successfully or not. If the CU 612 has a bundle that is ready to be processed, then the CU 612 inserts its ID to the CU Ready-Queue 608. If the worker reports success and the bundle that has been processed has not changed, then the bundle data is deleted from the CU 612, but its metadata is preserved for handling transport commits of offsets. For example, the bundle that has been processed may not have been replaced by a newer version. In some examples, in the case of a failure, retries may be executed with an exponential backoff policy until a success or a newer bundle arrives. For example, the success or newer bundle arrival may cause the failing bundle to be dropped or replaced.

Still referring to FIG. 6, the processing logic layer 614 includes logic needed for handling bundles. For example, the processing logic layer 614 can handle more than one bundle. For example, for apps the same processing logic might be used to handle bundles of type Clusters-per-Application, App-Status, and App-Status-Deltas. In various examples, the processing logic layer 614 registers its handler functions per bundle type within the CUs 612.

The workers pool 616 is a pool of threads where each worker can process bundles in parallel using the handler functions. In various examples, the workers pool 616 can be initialized with the maximum number of bundles that can be processed in parallel depending on any number of parameters. For example, the parameters may include the number of cores, maximum number of database connections, etc. The workers pool 616 includes a predetermined number of workers. For example, the predetermined number of workers may be a total of 50 workers. Every time a worker is available to process a bundle, the worker receives a bundle ready to be processed from the dispatcher 610. When the worker completes the processing, the worker is returned back to the workers pool 616. In the next cycle, the same worker may process a bundle of a different RH, according to whatever the dispatcher 616 will assign to the worker.

In various examples, the dispatcher 610 requests the next ready to be processed via the CU pointer, as indicated by arrow 632. The dispatcher 610 then assigns ready bundles to workers in the workers pool 616. For example, the dispatcher 610 may constantly be trying to read ready to be processed bundles and then delegate their processing to workers in the workers pool 616. The logic in the dispatcher 610 includes reading the next CU pointer 622A from the CU ready queue 608 and next available worker is taken from the workers pool 616. Then the bundle that is read from that CU pointer is assigned for processing on that worker. The fact that CU is inserted into the CU ready queue 608 only when the CU is not already there or during processing is what validates that only one bundle at most from a group of dependent bundles (group of bundles that have dependencies between them) can be processed at any given time. As shown in FIG. 6, the dispatcher 610 has accordingly selected and thus removed the next CU from the queue, which corresponds to CU pointer 622A. The dispatcher 610 can then utilize the workers pool 616 for processing bundles. For example, the dispatcher 610 can read each bundle from the CU 612 and run a corresponding handler function to process each type of bundle. In particular, the dispatcher 610 is shown reading CpA bundle 504, as indicated by arrow 634. The dispatcher 610 runs its handler function using a worker 624B, as shown at arrow 636. In the example of FIG. 6, workers 624A and 624C are shown simultaneously processing bundles 502 and 508 of example CU 612, as indicated by arrows 638 and 640. In various examples, the bundle handlers for specific types of bundles may have been registered by the processing logic layer 614 upon startup of the system 600, as indicated by an arrow 642. A more detailed description of the dispatcher 610 is provided with respect to the example system 700 of FIG. 7.

As shown with an arrow from worker 624C processing the delta bundle 508, once processing of the bundles for the CU 612A is completed, the workers pool 616 reports a status to the CUS 612, as indicated by an arrow 644. For example, the reported status may indicate that the scalable DB 618 has been successfully updated with information from a particular regional hub. Alternatively, or in addition, in some examples, the workers pool 616 can report an error during processing. In various examples, different errors may require different handling.

It is to be understood that the block diagram of FIG. 6 is not intended to indicate that the system 600 is to include all of the components shown in FIG. 6. Rather, the system 600 can include fewer or additional components not illustrated in FIG. 6 (e.g., additional layers, or additional transport readers, conflation units, bundle types, conflation unit pointers, dispatchers, workers, databases, etc.). For example, the conflation mechanism of system 600 may also include a management layer of the various conflation units and synchronization mechanisms to verify that there are no race conditions while updating a particular conflation unit by multiple readers in parallel.

With reference now to FIG. 7, a block diagram shows an example system for dispatching ready to be processed bundles to workers in a worker pool. The example system 700 of FIG. 7 includes similarly referenced elements from FIGS. 5 and 6. System 700 further includes a set of available workers 702 in the workers pool 616, which may be a database worker pool dedicated to executing updates to a database. The example system 700 further includes a database (DB) connection pool 704 communicatively coupled to the workers 622A, 622B, and 622C of a set of working workers 706. In the example of FIG. 7, the processing logic layer (not shown) may include instructions to insert the data into a scalable database, as in FIG. 6.

In the example of FIG. 7, the dispatcher 610 delegates ready to be processed bundles to workers 706 in the worker pool 616. For example, the dispatcher 610 may perform the following sequence endlessly. First the dispatcher 610 obtains a CU ID from the CU Ready-Queue 608, as shown by arrow 708. For example, the CU ID may be in the form of a CU pointer. In some examples, the dispatcher 610 can block or wait until a new CU ID becomes available in response to detecting that the CU Ready-Queue 608 is empty. For example, the dispatcher 610 can wait on a pop from the CU Ready-Queue 608.

In various examples, the dispatcher 610 can acquire workers 706 from the worker pool 616. If no worker is available block or wait until a worker 706 becomes available. In the example of FIG. 7, the dispatcher 610 has acquired worker 624A to process bundle 504. The dispatcher 610 can then access the CU 612 by its ID and request a bundle to process, such as bundle 504, as indicated by an arrow 712. The CU 612 returns the next bundle to process with bundle metadata, which was CpA bundle 504 in the example of FIG. 7. In various examples, the metadata is used by the CU 612 to identify the bundle, committing offsets, and for other purposes. The dispatcher 610 can then delegate bundle processing to the acquired worker with a CU pointer, as indicated by an arrow 714. In the example of FIG. 7, worker 624A is shown processing bundle 504 of CU 612 using CU pointer 622A to run a database job. Once processing is completed, the worker 706 reports the CU 612 that the bundle processing completed and provides the bundle's metadata and processing result, as indicated by an arrow 716. For example, the processing result may be a success or a failure with a reason for the failure. The workers 706 may then be returned to the workers pool 616 for additional assignments, as indicated by an arrow 718. The dispatcher 610 may then start the process over by obtaining another CU ID from the CU Ready-Queue 608 and repeating the above process. For example, the next CU pointer 622B may be used to select a different CU 612 for processing bundles therein.

It is to be understood that the block diagram of FIG. 7 is not intended to indicate that the system 700 is to include all of the components shown in FIG. 7. Rather, the system 700 can include fewer or additional components not illustrated in FIG. 7 (e.g., additional layers, or additional conflation units, bundle types, conflation unit pointers, dispatchers, workers, etc.).

The descriptions of the various embodiments of the present techniques have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising a processor to:
receive state bundles comprising full state bundles and delta bundles with dependencies corresponding to updates received via a transport layer from a lower layer in a multi-layer edge architecture;
conflate the state bundles to generate ready to be processed bundles; and
process the ready to be processed bundles.

2. The system of claim 1, wherein the full state bundles comprise updates of a same type received from the lower layer bundled into a single versioned full state bundle.

3. The system of claim 1, wherein the full state bundles comprise a managed endpoints bundle that contains a status of all managed endpoints of a reporting regional hub.

4. The system of claim 1, wherein the full state bundles comprise an endpoints per resource bundle that contains a mapping between a resource that was deployed and the endpoints associated with the deployed resource.

5. The system of claim 4, wherein the full state bundles comprise a resource status bundle that contains a mapping between a resource and a list of endpoints that the resource was deployed to along with their status.

6. The system of claim 5, wherein the delta state bundles comprise a resource status delta state bundle.

7. The system of claim 6, wherein the resource comprises an application.

8. The system of claim 1, wherein the processor is to treat endpoints according to a most frequent status and only receive updates for resources on endpoints that have a status other than the most frequent status, wherein the processor is to treat endpoints that were not reported as having reported the most frequent status.

9. The system of claim 1, comprising a plurality of conflation units, wherein each of the plurality of conflation units conflate bundles of a group of dependent bundles and sends ready to be processed bundles to a dispatcher for processing in a predefined order based on the dependencies.

10. The system of claim 1, comprising a transport reader that reads messages including the state bundles from the transport layer, extracts the state bundles, and inserts the extracted state bundles into a matching conflation unit.

11. The system of claim 1, comprising a dispatcher to request a ready to be processed bundle and assign a worker from a workers pool to process the ready to be processed bundle.

12. A computer-implemented method, comprising:
receiving, via a processor, state bundles comprising full state bundles and delta bundles with dependencies corresponding to updates received via a transport layer from a lower layer in a multi-layer edge architecture;
conflating, via the processor, the state bundles to generate ready to be processed bundles; and
processing, via the processor, the ready to be processed bundles.

13. The computer-implemented method of claim 12, wherein processing the ready to be processed bundles comprises processing different state bundle types in a predefined order that is based the dependencies between the different state bundle types.

14. The computer-implemented method of claim 12, wherein processing the ready to be processed bundles is executed using a plurality of assigned workers, wherein the plurality of workers handle ready to be processed bundles.

15. The computer-implemented method of claim 12, wherein processing the ready to be processed bundles is executed using a workers pool.

16. The computer-implemented method of claim 12, wherein receiving state bundles comprises receiving full state bundles from a regional hub in response to a disconnection with the regional hub, and transmitting an acknowledgement to the regional hub and receiving a delta state bundle in response to transmitting the acknowledgement.

17. The computer-implemented method of claim 12, further comprising reporting a latest status of the processing of the ready to be processed bundles.

18. The computer-implemented method of claim 12, wherein conflating the bundles is executed in response to detecting that a processing rate of the processor is slower than the rate of data received by the transport layer.

19. The computer-implemented method of claim 12, wherein processing the ready to be processed bundles comprises processing groups of dependent bundles received from a same regional hub one at a time.

20. The computer-implemented method of claim 12, comprising receiving the state bundles from a plurality of regional hubs and conflating the state bundles based on their dependencies.

21. A computer program product for processing updates in multi-layer edge architectures, the computer program product comprising a computer-readable storage medium having program code embodied therewith, the program code executable by a processor to cause the processor to:
receive state bundles comprising full state bundles and delta bundles with dependencies corresponding to updates received via a transport layer from a lower layer in a multi-layer edge architecture;
conflate the state bundles to generate ready to be processed bundles; and
process the ready to be processed bundles.

22. The computer program product of claim 21, further comprising program code executable by the processor to process different state bundle types in a predefined order that is based the dependencies between the different state bundle types.

23. The computer program product of claim 21, further comprising program code executable by the processor to process the ready to be processed bundles using a plurality of assigned workers.

24. The computer program product of claim 21, further comprising program code executable by the processor to process the ready to be processed bundles using a workers pool.

25. The computer program product of claim 21, further comprising program code executable by the processor to receive full state bundles from a regional hub in response to a disconnection with the regional hub, and transmit an acknowledgement to the regional hub and receive a delta state bundle in response to transmitting the acknowledgement.
